(19) United States
(12) Patent Application Publication
(10) Pub. No.: US 2025/0299866 A1
(43) Pub. Date: Sep. 25, 2025

(54) REACTOR INCLUDING OUTER PERIPHERAL CORE

(71) Applicant: Fanuc Corporation, Minamitsuru-gun, Yamanashi (JP)

(72) Inventor: Tomokazu YOSHIDA, Minamitsuru-gun, Yamanashi (JP)

(73) Assignee: Fanuc Corporation, Minamitsuru-gun, Yamanashi (JP)

(21) Appl. No.: 18/861,974

(22) PCT Filed: May 10, 2022
(86) PCT No.: PCT/JP2022/019857

§ 371 Date: Oct. 31, 2024

(51) Int. Cl. H01F 27/24; H01F 27/28

(52) U.S. Cl. CPC H01F 27/24; H01F 27/28

(57) ABSTRACT

A reactor includes a core main body including an outer peripheral core, at least three cores, and at least three coils. Gaps, which can be magnetically coupled together, are formed respectively between two adjacent cores. The reactor includes a vibration suppressing section fixing at least three cores. The vibration suppressing section includes two fixing plates and a bar-like member that clamps the two fixing plates. At least one of the two fixing plates includes at least three notches extending from an edge toward the center of the fixing plate.

### CROSS REFERENCE TO RELATED APPLICATIONS

This is the U.S. National Phase application of PCT/JP2022/019857, filed May 10, 2022, the disclosures of this application being incorporated herein by reference in its entirety for all purposes.

### FIELD OF THE INVENTION

The present invention relates to a reactor comprising an outer peripheral iron core.

### BACKGROUND OF THE INVENTION

In recent years, reactors which comprise an outer peripheral iron core and a plurality of iron core coils arranged inside the outer peripheral iron core have been developed. Each of the plurality of iron core coils includes an iron core and a coil wound around the iron core.

### PATENT LITERATURE

[PTL 1] Japanese Unexamined Patent Publication (Kokai) No. 2018-206949

[PTL 2] Japanese Unexamined Patent Publication (Kokai) No. 2020-178081

[PTL 3] Japanese Unexamined Patent Publication (Kokai) No. 2018-117047

### SUMMARY OF THE INVENTION

In order to suppress the vibrations and noise generated by the plurality of iron cores during use of a reactor, Japanese Unexamined Patent Publication (Kokai) No. 2018-206949 and Japanese Unexamined Patent Publication (Kokai) No. 2020-178081 each disclose a vibration suppressor as a fixture composed of two plate-shaped members and a plurality of rod-shaped members. Further, the vibration suppressor disclosed in Japanese Unexamined Patent Publication (Kokai) No. 2018-117047 comprises an extension which engages with the upper surfaces of the iron cores.

However, since iron cores are produced by stacking a plurality of magnetic plates, when the heights of the iron cores vary, it is difficult to firmly affix the iron cores with the fixtures of Japanese Unexamined Patent Publication (Kokai) No. 2018-206949 and Japanese Unexamined Patent Publication (Kokai) No. 2020-178081. Furthermore, since the extension of Japanese Unexamined Patent Publication (Kokai) No. 2018-117047 engages only a portion of the iron cores in the width direction, vibrations and noise may become greater. It is also desired to simplify the structure of the vibration suppressor and reduce production costs.

Thus, there is a need for a reactor in which noise and vibration can be suppressed at low cost while absorbing variations in the height of each iron core.

According to a first aspect of the present disclosure, there is provided a reactor, comprising a core body, the core body comprising an outer peripheral iron core composed of a plurality of outer peripheral iron core portions, at least three iron cores coupled to the plurality of outer peripheral iron core portions, and coils wound around the at least three iron cores, wherein magnetically couplable gaps are formed between one of the at least three iron cores and another iron core adjacent thereto, the reactor further comprising a vibration suppressor for securing the at least three iron cores, wherein the vibration suppressor comprises two affixation plates and one rod-shaped member that connects the two affixation plates to each other, and in at least one of the two affixation plates there are formed at least three notches extending from the edge of the affixation plate toward a center thereof.

In the first aspect, since notches are present in the affixation plate, the edges of the affixation plate between two adjacent notches can be individually bent. Thus, each edge is curved in accordance with the height of the corresponding iron core, and as a result, variations in the height of each iron core can be absorbed. Since it is sufficient to form a notch into the affixation plate, formation is easy and production costs can be reduced. Furthermore, since only a single rod-shaped member is present, even if the vibration suppressor is composed of a magnetic material, current will not flow through the vibration suppressor in a loop shape, whereby heat generation in the reactor can be prevented.

The object, characteristics, and advantages of the present invention will become more apparent from the following description of the embodiments in conjunction with the accompanying drawings.

### BRIEF DESCRIPTION OF DRAWINGS

FIG. 1 is a partial perspective view of a reactor of a first embodiment.

FIG. 2 is a cross-sectional view of the core body of the reactor of the first embodiment.

FIG. 3 is a perspective view of the vibration suppressor of the first embodiment.

FIG. 4A is a top view of the affixation plate of the vibration suppressor of the first embodiment.

FIG. 4B is a top view of the affixation plate of the vibration suppressor of the fifth embodiment.

FIG. 5 is a partial perspective view of the reactor of a second embodiment.

FIG. 6 is a partial perspective view of the reactor of a third embodiment.

FIG. 7 is a perspective view of the reactor of a fourth embodiment.

FIG. 8 is a perspective view of the vibration suppressor of the fourth embodiment.

FIG. 9A is a top view of the affixation plate of the fourth embodiment.

FIG. 9B is a side view of the affixation plate taken along line A-A′ of FIG. 9A.

FIG. 10 is a view detailing how the vibration suppressor is attached to the reactor of the fourth embodiment.

FIG. 11 is a perspective view of a bent affixation plate of yet another embodiment.

FIG. 12 is a perspective view of the vibration suppressor of another embodiment.

FIG. 13 is a partial perspective view of the reactor of a fifth embodiment.

FIG. 14 is a cross-sectional view of the core body of the reactor of the fifth embodiment.

### DETAILED DESCRIPTION OF EMBODIMENTS OF THE INVENTION

The embodiments of the present invention will be described below with reference to the attached drawings. In the drawings, corresponding constituent elements have been assigned common reference signs.

In the following description, though a three-phase reactor will be primarily described as an example, the applications of the present disclosure are not limited to three-phase reactors, but the present disclosure is widely applicable to multi-phase reactors which require constant inductance in each phase. Furthermore, the reactor according to the present disclosure is not limited to being provided on the primary side or secondary side of an inverter in an industrial robot or a machine tool, but can be applied to various devices.

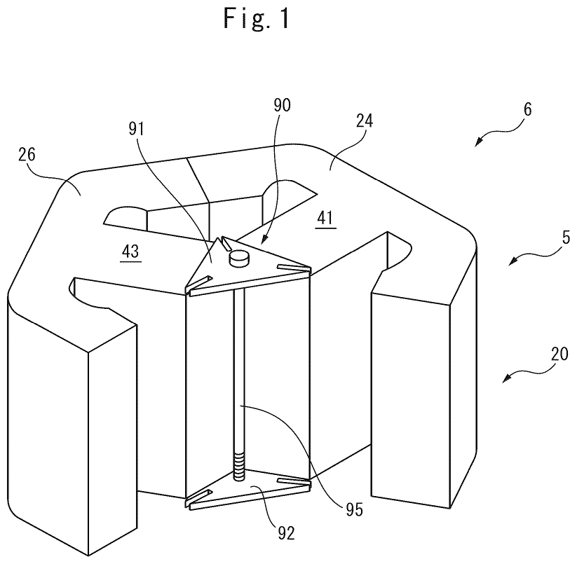

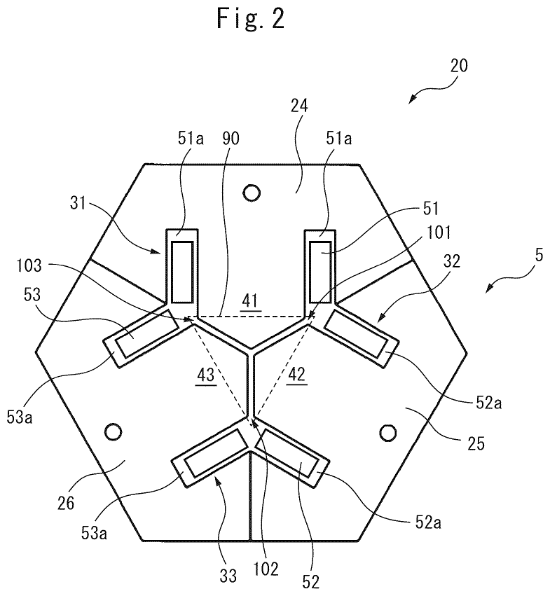

FIG. 1 is a partial perspective view of a reactor of a first embodiment. FIG. 2 is a cross-sectional view of a core body of the reactor of the first embodiment. In particular, as shown in FIG. 2, a core body 5 of the reactor 6 comprises an outer peripheral iron core 20 and three iron core coils 31 to 33 arranged inside the outer peripheral iron core 20. In FIG. 2, the iron core coils 31 to 33 are arranged inside the outer peripheral iron core 20, which is substantially hexagonal. These iron core coils 31 to 33 are arranged at equal intervals in the circumferential direction of the core body 5.

The outer peripheral iron core 20 may have another rotationally symmetric shape, such as a circular shape. The number of the iron core coils may be any multiple of three, in which case the reactor 6 can be used as a three-phase reactor.

As can be seen from the drawings, the iron core coils 31 to 33 respectively include iron cores 41 to 43 that extend only in the radial direction of the outer peripheral iron core 20, and coils 51 to 53 that are wound around the iron cores. Note that in FIG. 1 and other drawings described later, illustration of the coils 51 to 53, the iron core 42, and the outer peripheral iron core portion 25 may be omitted for the purpose of simplification.

The outer peripheral iron core 20 is composed of a plurality of, for example, three, outer peripheral iron core portions 24 to 26 divided in the circumferential direction. The outer peripheral iron core portions 24 to 26 are integrally formed with the iron cores 41 to 43, respectively. The outer peripheral iron core portions 24 to 26 and the iron cores 41 to 43 are formed by stacking a plurality of magnetic plates, for example, iron plates, carbon steel plates, and electromagnetic steel plates, in the axial direction of the reactor, or by compacting iron core powder. When the outer peripheral iron core 20 is composed of a plurality of outer peripheral iron core portions 24 to 26 in this manner, such an outer peripheral iron core 20 can be easily produced even if the outer peripheral iron core 20 is large. The number of the iron cores 41 to 43 and the number of the outer peripheral iron core portions 24 to 26 need not necessarily match.

The coils 51 to 53 are arranged in coil spaces 51a to 53a formed between the outer peripheral iron core portions 24 to 26 and the iron cores 41 to 43. In the coil spaces 51a to 53a, the inner and outer circumferential surfaces of the coils 51 to 53 are adjacent to the inner walls of the coil spaces 51a to 53a.

Furthermore, the radially inner ends of the iron cores 41 to 43 are located near the center of the outer peripheral iron core 20. In the drawings, the radially inner ends of the iron cores 41 to 43 converge toward the center of the outer peripheral iron core 20, with a tip angle of approximately 120 degrees. The radially inner ends of the iron cores 41 to 43 are separated from one another via magnetically-couplable gaps 101 to 103.

In other words, the radially inner end of the iron core 41 is separated from the radially inner ends of the two adjacent iron cores 42, 43 via the gaps 101, 102. The same is true for the other iron cores 42, 43. The dimensions of the gaps 101 to 103 are designed to be equal to each other.

In this manner, in the configuration shown in FIG. 1, since the central iron core located at the center of the core body 5 is not necessary, the core body 5 can be constructed light and simply. Further, since the three iron core coils 31 to 33 are surrounded by the outer peripheral iron core 20, the magnetic fields generated from the coils 51 to 53 do not leak outside the outer peripheral iron core 20. Furthermore, the gaps 101 to 103 can be provided at any thickness at low cost, which is advantageous in terms of design as compared to reactors having the conventional structure.

Further, in the core body 5 of the present disclosure, since the difference in magnetic path length between phases is smaller than in reactors having the conventional structure, in the present disclosure, the imbalance of inductance caused by differences in magnetic path length can be reduced.

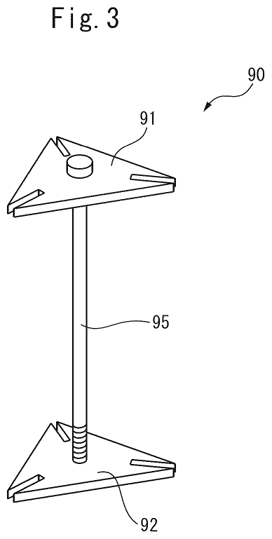

Referring again to FIG. 1, a vibration suppressor 90 is arranged at the center of the end surface of the core body 5. The vibration suppressor 90 serves to affix both end surfaces of the iron cores 41 to 43 to each other in the axial direction of the core body 5. FIG. 3 is a perspective view of the vibration suppressor of the first embodiment. As shown in FIG. 3, the vibration suppressor 90 includes two affixation plates 91, 92 and a single rod-shaped member 95 that connects the affixation plates 91, 92 to each other.

As can be understood from FIG. 1, the affixation plates 91, 92 are arranged on each end surfaces of the core body 5. In the first embodiment, the affixation plates 91, 92 are preferably triangular flat plates having an area that can include the gaps 101 to 103, so that the affixation plates 91, 92 do not interfere with the coils 51 to 53. The affixation plates 91, 92 may also be of another polygonal shape or may be circular.

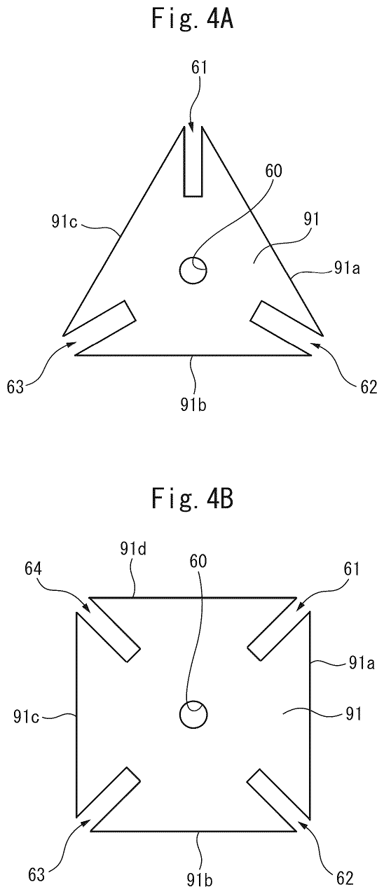

FIG. 4A is a top view of the affixation plates of the vibration suppressor of the first embodiment. Though the affixation plate 91 is shown in FIG. 4A, the affixation plate 92 is preferably of the same shape. However, the affixation plates 91, 92 need not necessarily have the same shape. Furthermore, notches, which will be described later, may be formed in only one of the affixation plates.

At least three notches 61 to 63 extending from the peripheral edge toward the center of the affixation plate 91 are formed. In the embodiment shown in FIG. 4A, the at least three notches 61 to 63 extend partially toward the center from each vertex of the triangular affixation plate 91. As illustrated, the peripheral edges of the affixation plate 91 located between each of the notches 61 to 63 are referred to as edges 91a to 91c.

In the first embodiment, as can be seen from FIG. 1, the rod-shaped member 95 passes through the interior of the outer peripheral iron core 20 at the intersection of the gaps 101 to 103. The rod-shaped member 95 is slightly larger than the height (height in the lamination direction) of the core body 5. A typical rod-shaped member 95 is a bolt, and threading 94 is formed on at least one end side of the rod-shaped member 95. Thus, the rod-shaped member 95 is screwed into a hole formed in the affixation plate 92.

As described above, the areas of the affixation plates 91, 92 may include the gaps 101 to 103. Thus, when the core body 5 is axially interposed between the affixation plates 91, 92 by the rod-shaped member 95, both ends of the plurality of iron cores 41 to 43 are firmly held to each other.

As described above, the notches 61 to 63 are formed in at least one of the affixation plates 91. Thus, the distance between the closed ends of each of the two adjacent notches 61 to 63 is shorter than the distance between the open ends of the notches 61 to 63 (the length of each of the edges 91a to 91c). Thus, a portion of the affixation plate 91 located between the two adjacent notches 61 to 63 exhibits spring properties, and each of the edges 91a to 91c can be bent individually.

In this manner, when the vibration suppressor 90 is assembled, each of the edges 91a to 91c is curved according to the height of the corresponding iron cores 41 to 43, and for example, the stacking height. In a state in which the variations in height of each of the iron cores 41 to 43 is absorbed, the affixation plates 91, 92 act to pull each other. This allows both ends of the plurality of iron cores 41 to 43 to be firmly held together, further suppressing the generation of vibrations and noise when the reactor is driven. Since it is sufficient to only form the notches 61 to 63 into the affixation plates 91, 92, the vibration suppressor 90 is easy to form and the produced costs are reduced.

Furthermore, the components of the vibration suppressor 90 may be made from a non-magnetic material or may be made from a magnetic material. This is because there is a single rod-shaped member 95 in the present disclosure. In contrast, if the two affixation plates are fixed by a plurality of rod-shaped members, for example, three rod-shaped members, and the two affixation plates and the rod-shaped members are magnetic, when the reactor is driven, current flows in a loop through the two affixation plates and the plurality of rod-shaped members. This may cause the reactor to heat up and cause breakdown. In other words, in the present disclosure, even if the entire vibration suppressor 90 is made from a magnetic material, a current does not flow in a loop through the vibration suppressor 90, and heating of the reactor can be prevented.

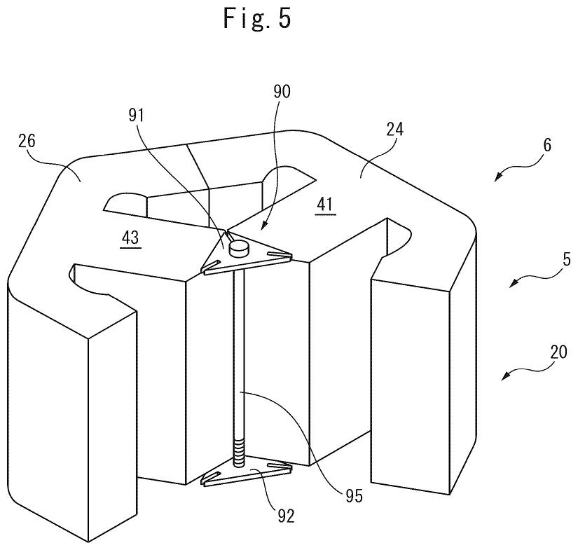

FIG. 5 is a partial perspective view of the reactor of a second embodiment. The affixation plates 91, 92 shown in FIG. 5 are smaller than the affixation plates 91, 92 shown in FIG. 1. Even in such a case, the distance between the open ends of two adjacent notches 61 to 63, for example, the length of each of the edges 91a to 91c, is preferably equal to or greater than half the width of the corresponding iron cores 41 to 43. Since each edge 91a to 91c of the affixation plates 91, 92 secures most of the width of the iron cores 41 to 43 in this manner, vibrations and noise can be sufficiently suppressed.

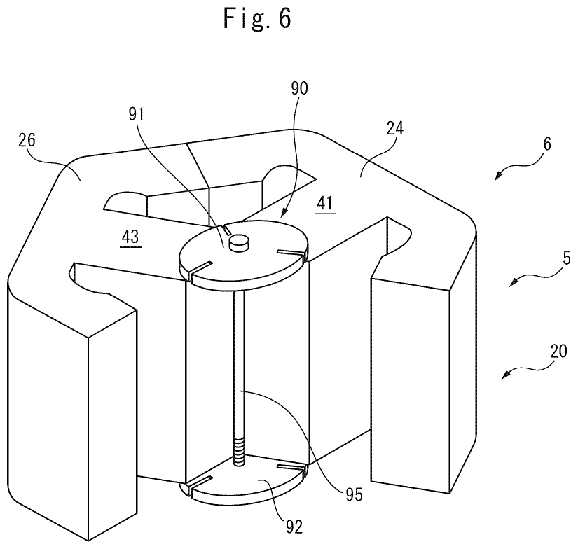

FIG. 6 is a partial perspective view of the reactor of a third embodiment. The affixation plates 91, 92 shown in FIG. 6 are circular. The diameters of the affixation plates 91, 92 are preferably selected so as not to interfere with the coils 51 to 53. As described above, the distance between the open ends of two adjacent notches 61 to 63 is preferably equal to or greater than half the width of the corresponding iron cores 41 to 43. It will be understood that in the third embodiment, the affixation plates 91, 92 can be easily formed.

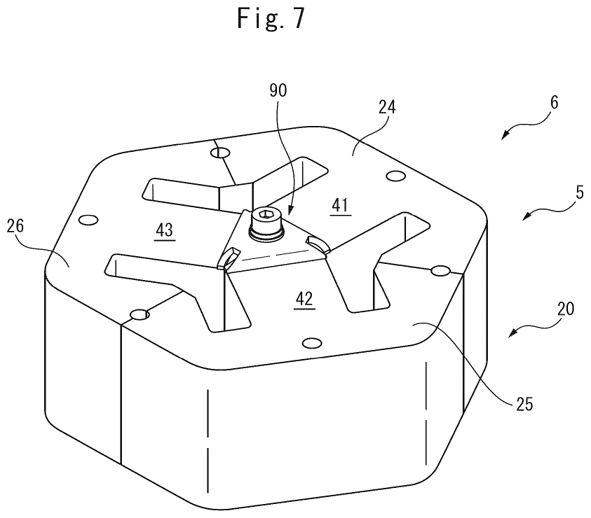

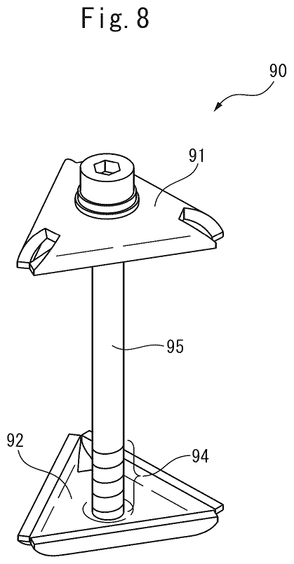

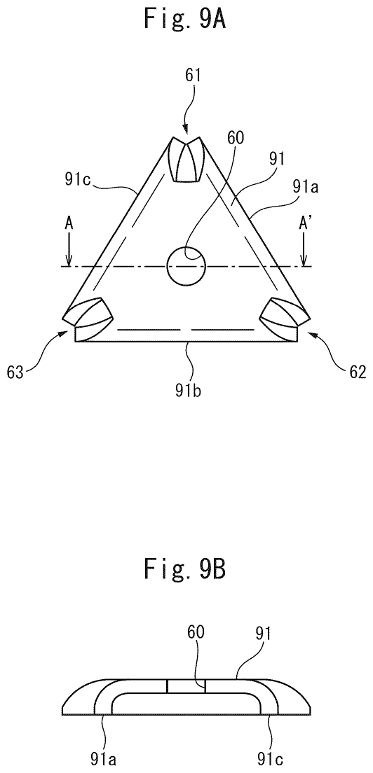

FIG. 7 is a perspective view of the reactor of a fourth embodiment, and FIG. 8 is a perspective view of a vibration suppressor of the fourth embodiment. FIG. 9A is a top view of a affixation plate of the fourth embodiment, and FIG. 9B is a side view of the affixation plate taken along line A-A′ of FIG. 9A.

In the fourth embodiment, at least one of the affixation plates 91 of the vibration suppressor 90 is made from a magnetic material, for example, a metal. Each edge 91a to 91c of the affixation plate 91 is bent at a predetermined angle, for example, 90°, with respect to the surface of the affixation plate 91. In this case, a part of the affixation plate 91 located between two adjacent notches 61 to 63 further exhibits spring properties. As a result, it can be seen that vibrations and noise generated when the reactor is driven can be further suppressed at low cost. Naturally, the angle at which each edge 91a to 91c is bent may be a value other than 90°.

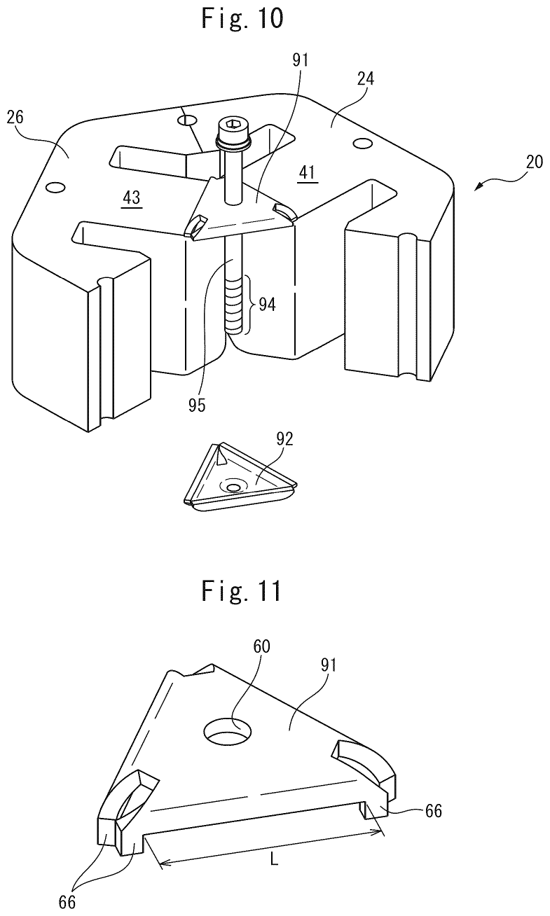

FIG. 10 is a view detailing how the vibration suppressor is attached to the reactor of the fourth embodiment. For the purpose of facilitating understanding, the outer peripheral iron core portion 25 has been omitted in FIG. 10. First, the rod-shaped member 95 is inserted into a hole 60 of the affixation plate 91.

The affixation plate 91 is then moved toward one end surface of the core body 5, so that the rod-shaped member 95 passes through the intersection of the gaps 101 to 103. When the affixation plate 91 reaches one end surface of the core body 5, the tip of the rod-shaped member 95 protrudes from the other end of the core body 5. Next, the affixation plate 92 is placed on the other end surface side of the core body 5, and the rod-shaped member 95 is rotated and screwed into the affixation plate 92. For this purpose, it is preferable that threading be formed on the tip of the rod-shaped member 95 and at the through hole 60 of the affixation plate 92. Naturally, other fasteners may be used to connect the affixation plates 91, 92 to the rod-shaped member 95.

FIG. 11 is a perspective view of a bent affixation plate of yet another embodiment. In FIG. 11, protrusions 66 are formed on both ends of the bent edge of the affixation plate 91. Such protrusions 66 may be created by cutting the edges 91a to 91c before and after bending, or may be created by bending a flat plate already shaped with the protrusions 66.

In FIG. 11, each edge 91a to 91c includes two protrusions 66. The inner dimension L between the two protrusions 66 is preferably approximately equal to the width of the corresponding iron cores 41 to 43. In this case, both ends of each edge 91a to 91c engage with the side surfaces of the iron cores 41 to 43, respectively. In other words, since the iron cores 41 to 43 are interposed between the two protrusions 66, vibrations and noise caused by the iron cores 41 to 43 moving in the circumferential direction of the reactor can be prevented.

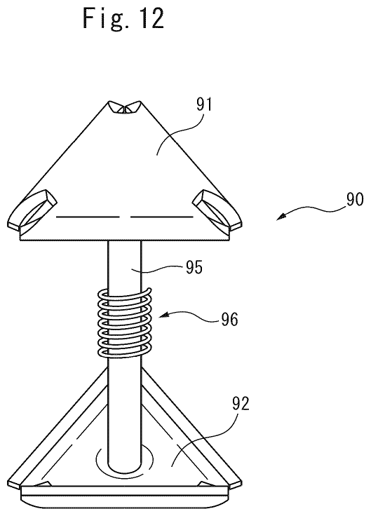

FIG. 12 is a perspective view of a vibration suppressor of another embodiment. In FIG. 12, an elastic member 96, for example, a spring, is arranged in the middle of a rod-shaped member 95. Strictly speaking, the rod-shaped member 95 shown in FIG. 12 includes two rod bodies and an elastic member 96 that connects these rod bodies to each other. In this case, since the elastic member 96 biases the two affixation plates 91, 92 toward each other, noise and vibration can be further suppressed.

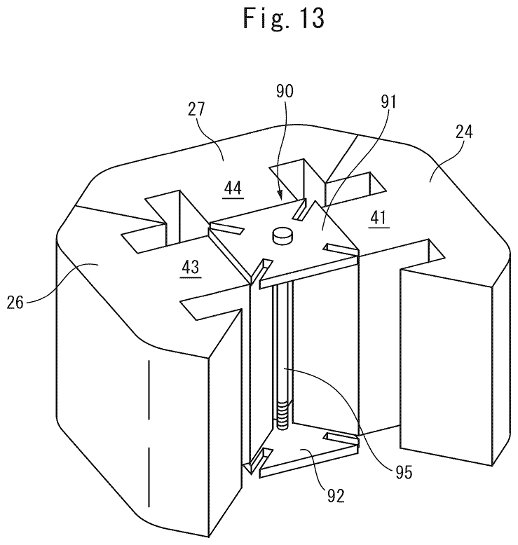

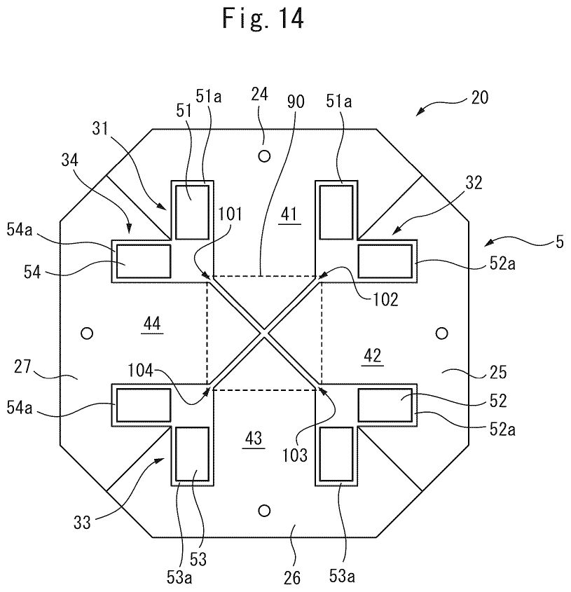

FIG. 13 is a partial perspective view of the reactor of a fifth embodiment, and FIG. 14 is a cross-sectional view of the core body of the reactor of the fifth embodiment. The core body 5 shown in FIG. 14 includes an outer peripheral iron core 20 having a substantially octagonal shape, and four iron core coils 31 to 34 similar to those described above, which are arranged inside the outer peripheral iron core 20. These iron core coils 31 to 34 are arranged at equal intervals in the circumferential direction of the core body 5. The number of iron cores is preferably an even number of four or more, whereby the reactor including the core body 5 can be used as a single-phase reactor.

As can be seen from the drawing, the outer peripheral iron core 20 is divided into four outer peripheral iron core portions 24 to 27 in the circumferential direction. Each of the iron core coils 31 to 34 includes an iron core 41 to 44 extending in the radial direction and a coil 51 to 54 wound around the iron core. The radially outer end of each of the iron cores 41 to 44 is integrally formed with each of the outer peripheral iron core portions 21 to 24. The number of the iron cores 41 to 44 need not necessarily match the number of the outer peripheral iron core portions 24 to 27.

The radially inner ends of the iron cores 41 to 44 are positioned near the center of the outer peripheral iron core 20. In FIG. 14, the radially inner ends of the iron cores 41 to 44 converge toward the center of the outer peripheral iron core 20, with a tip angle of approximately 90 degrees. The radially inner ends of the iron cores 41 to 44 are separated from one another via magnetically-couplable gaps 101 to 104.

FIG. 4B is a top view of the affixation plate of the vibration suppressor of the fifth embodiment. The affixation plate 91 shown in FIG. 4B has a substantially rectangular shape having an area that can include the gaps 101 to 104, and the notches 61 to 64 similar to those described above extend from the apex of the affixation plate 91 toward the center. As described above, when the core body 5 is interposed between the affixation plates 91, 92 in the axial direction by the rod-shaped member 95, both ends of the iron cores 41 to 44 are affixed to each other. It will be understood that the same effects as described above can be obtained in this case as well. Furthermore, appropriate combinations of the embodiments described above are included in the scope of the present disclosure.

### Aspects of the Present Disclosure

According to the first aspect, there is provided a reactor, comprising a core body, the core body comprising an outer peripheral iron core composed of a plurality of outer peripheral iron core portions, at least three iron cores coupled to the plurality of outer peripheral iron core portions, and coils wound around the at least three iron cores, wherein magnetically couplable gaps are formed between one of the at least three iron cores and another iron core adjacent thereto, the reactor further comprising a vibration suppressor for securing the at least three iron cores, wherein the vibration suppressor comprises two affixation plates and one rod-shaped member that connects the two affixation plates to each other, and in at least one of the two affixation plates there are formed at least three notches extending from the edge of the affixation plate toward a center thereof.

According to the second aspect, in the first aspect, a distance between two adjacent notches among the at least three notches is equal to or greater than half the width of the iron core.

According to the third aspect, in the first or second aspect, the affixation plate in which the at least three notches are formed has a polygonal shape, a number of sides of the polygonal shape is greater than or equal to a number of the at least three iron cores, and the at least three notches extend from vertices of the polygonal shape toward a center thereof.

According to the fourth aspect, in the third aspect, each edge of the polygonal affixation plate is bent.

According to the fifth aspect, in the fourth aspect, an inner dimension between both ends of each of the bent edges is approximately equal to the width of the iron core.

According to the sixth aspect, in the first or second aspect, the affixation plate in which the at least three notches are formed is circular.

According to the seventh aspect, in the first or second aspect, the rod-shaped member comprises a bolt.

According to an eighth aspect, in the first or second aspect, the rod-shaped member comprises an elastic member.

According to the ninth aspect, in the first or second aspect, a number of the at least three iron core coils is a multiple of three.

According to a tenth aspect, in the first or second aspect, a number of the at least three iron core coils is an even number of 4 or more.

### Effects of Aspects

In the first aspect, since the affixation plate has notches, the edges of the affixation plate between two adjacent notches can individually bend. Thus, each edge can be bent in accordance with the height of the corresponding iron core, and as a result, the variation in height of each iron core can be absorbed. Furthermore, since it is sufficient to only insert notches into the affixation plate, formation is easy and production cost can be kept low.

In the second aspect, since each edge of the affixation plate secures most of the width of the iron core, vibration and noise can be sufficiently suppressed.

In the third aspect, the affixation plates can easily be formed.

In the fourth aspect, the affixation plates have a spring function, which can further reduce vibration and noise at low cost.

In the fifth aspect, both ends of each edge engage with the side surface of the iron core, preventing vibration and noise caused by the iron core moving in the circumferential direction of the reactor.

In the sixth aspect, the affixation plates can easily be formed.

In the seventh aspect, noise and vibration can be further suppressed and the rod-shaped member can be produced inexpensively.

In the eighth aspect, the elastic member biases the two affixation plates closer to each other, further reducing noise and vibration.

In the ninth aspect, the reactor can be used as a three-phase reactor.

In the tenth aspect, the reactor can be used as a single-phase reactor.

Though the embodiments of the present invention have been described above, a person skilled in the art would understand that various modifications and changes can be made without deviating from the scope of the claims of the present disclosure, which are described later.

### DESCRIPTION OF REFERENCE SIGNS

5 core body
6 reactor
20 outer peripheral iron core
24 to 27 outer peripheral iron core portion
31 to 34 iron core coil
41 to 44 iron core
51 to 54 coil
61 to 64 notch
66 protrusion
90 vibration suppressor
91, 92 affixation plate
91a to 91c edge
94 threading
95 rod-shaped member
96 elastic member
101 to 104 gap

1. A reactor, comprising:
a core body,
the core body comprising an outer peripheral iron core composed of a plurality of outer peripheral iron core portions,
at least three iron cores coupled to the plurality of outer peripheral iron core portions, and
coils wound around the at least three iron cores, wherein
magnetically couplable gaps are formed between one of the at least three iron cores and another iron core adjacent thereto, the reactor further comprising:
a vibration suppressor for securing the at least three iron cores, wherein
the vibration suppressor comprises two affixation plates and one rod-shaped member that connects the two affixation plates to each other, and
in at least one of the two affixation plates there are formed at least three notches extending from the edge of the affixation plate toward a center thereof.

2. The reactor according to claim 1, wherein a distance between two adjacent notches among the at least three notches is equal to or greater than half the width of the iron core.

3. The reactor according to claim 1, wherein the affixation plate in which the at least three notches are formed has a polygonal shape,
a number of sides of the polygonal shape is greater than or equal to a number of the at least three iron cores, and
the at least three notches extend from vertices of the polygonal shape toward a center thereof.

4. The reactor according to claim 3, wherein each edge of the polygonal affixation plate is bent.

5. The reactor according to claim 4, wherein an inner dimension between both ends of each of the bent edges is approximately equal to a width of the iron core.

6. The reactor according to claim 1, wherein the affixation plate in which the at least three notches are formed is circular.

7. The reactor according to claim 1, wherein the rod-shaped member comprises a bolt.

8. The reactor according to claim 1, wherein the rod-shaped member comprises an elastic member.

9. The reactor according to claim 1, wherein a number of the at least three iron core coils is a multiple of three.

10. The reactor according to claim 1, wherein a number of the at least three iron core coils is an even number of 4 or more.
